(19) United States
(12) Patent Application Publication
(10) Pub. No.: US 2008/0232335 A1
(43) Pub. Date: Sep. 25, 2008

(54) Enhanced Network Allocation Vector Mechanism for Optimal Reuse of the Spectrum in a Wireless Communication System

(75) Inventors: Javier Del Prado Pavon, Ossining, NY (US); Sai Shankar Nandagopalan, Tarrytown, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,329

(22) PCT Filed: Jan. 31, 2005
(86) PCT No.: PCT/IB2005/050401

§ 371 Date: Jul. 20, 2006

Related U.S. Application Data
(60) Provisional application No. 60/541,080, filed on Feb. 2, 2004.
(60) Provisional application No. 60/575,276, filed on May 28, 2004.

(51) Int. Cl. H04Q 7/24

(52) U.S. Cl. 370/338

(57) ABSTRACT

Wireless networks and methods of use includes a source that transmits a signal to at least one destination during a scheduled time period. The network also includes at least one node, which is hidden from the destination, and which transmits a signal during the scheduled time period. The networks and their methods of use provide for efficient use of the medium.

This application claims the benefit, pursuant to 35 USC §119(e), to that provisional patent application filed on Feb. 2, 2004 in the United States Patent and Trademark Office and assigned Ser. No. 60/541,080, the contents of which are incorporated by reference herein.

The use of wireless connectivity in data and voice communications continues to increase. These devices include mobile telephones, portable computers, computers in a wireless local area network (WLAN), portable handsets and the like. The wireless communication bandwidth has significantly increased with advances of channel modulation techniques, making the wireless medium a viable alternative to wired and optical fiber solutions.

Each wireless network includes a number of layers and sub-layers. The Medium Access Control (MAC) sub-layer and the Physical (PHY) layer are two of these layers. The MAC layer is the lower of two sublayers of the Data Link layer in the Open System Interconnect (OSI) stack. IEEE 802.11 is a standard that covers the specification for the Medium Access Control (MAC) sub-layer and the Physical (PHY) layer of the WLAN. While this standard has provided for significant improvement in the control of voice and data traffic, the continued increase in the demand for network access at increased channel rates while supporting quality-of-service (QoS) requirements have required a continuous evaluation of the standard and change thereto. For example, much effort has been placed on support for real-time multimedia services in WLAN's, particularly with Quality of Service (QoS) guarantees.

As is well known, in many wireless communication networks, an emphasis is placed on protection of the receiver of frames from a transmitter, such as a host or access point. However, in known protocols, this results in the protection of transmitters and nodes that are hidden from the receiver of the frames. This results in the inefficient use of the network and its components. For example, if a transmitter is scheduled to transmit to a receiver during a scheduled transmission, under known techniques, in order to ensure protection of the receiver all nodes within the service area (range) of the transmitter, via a virtual reservation technique, are instructed to not to transmit so as to not interfere with the reception of the frames by the receiver. However, often there are nodes (devices) that are within the service area of the transmitter, and are far enough from the receiving node that their transmissions will not be received by the receiving node. As such, potential transmission and increased throughput is sacrificed needlessly by known techniques.

What is needed, therefore, is a method and apparatus that substantially overcomes at least the shortcomings of known methods described.

In accordance with an example embodiment, a wireless network includes a source that transmits a signal to at least one destination during a scheduled time period. The network also includes at least one node, which is hidden from the destination, and which transmits a signal during the scheduled time period.

In accordance with an example embodiment, a method of wireless communication includes providing a source that transmits a signal to at least one destination during a scheduled time period. The also includes providing at least one node, which is hidden from the destination, and which transmits a signal during the scheduled time period.

The invention is best understood from the following detailed description when read with the accompanying drawing figures. It is emphasized that the various features are not necessarily drawn to scale. In fact, the dimensions may be arbitrarily increased or decreased for clarity of discussion.

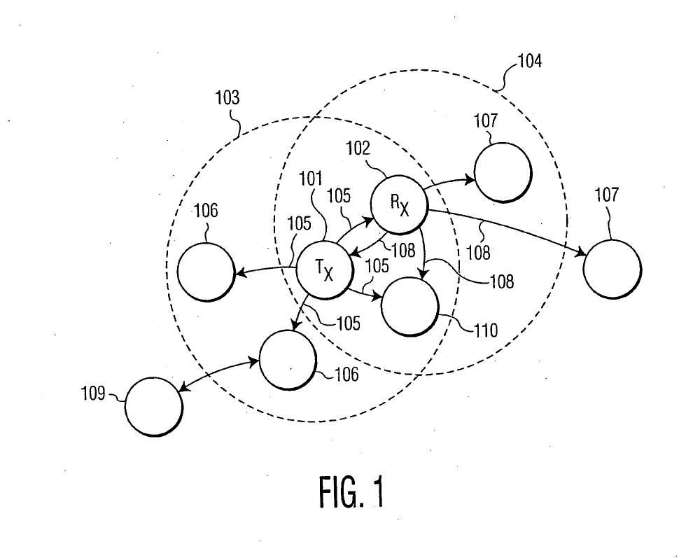

FIG. 1 is schematic representation of wireless communication network in accordance with an example embodiment.

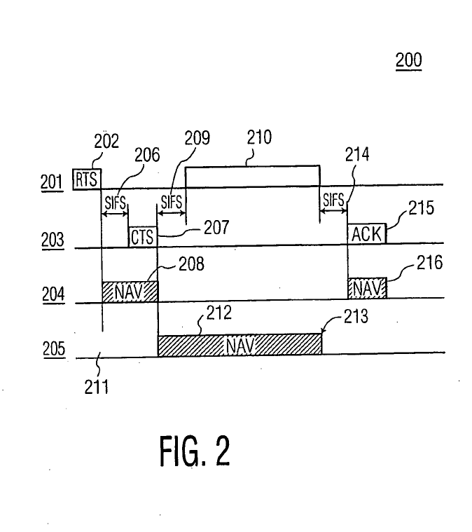

FIG. 2 is a time line showing of a known network allocation vector (NAV) protection mechanism.

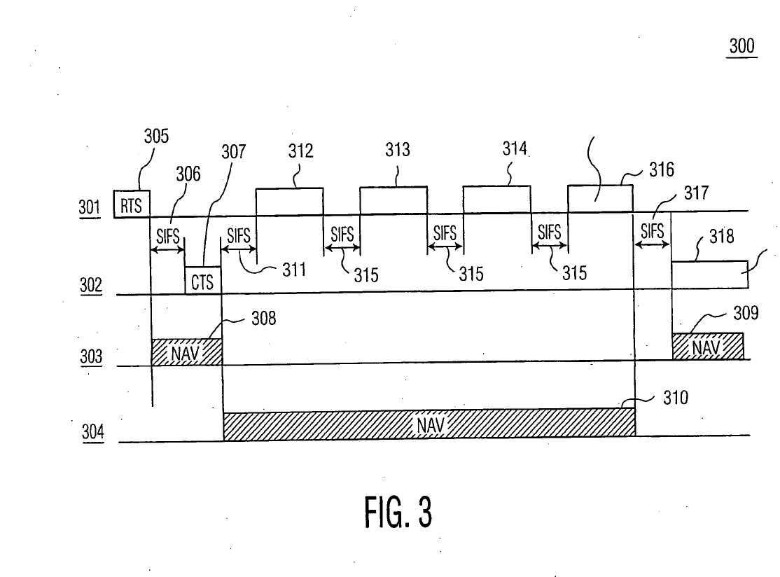

FIG. 3 is a time line showing a NAV technique according to an example embodiment.

In the following detailed description, for purposes of explanation and not limitation, example embodiments disclosing specific details are set forth in order to provide a thorough understanding of the example embodiments.

However, it will be apparent to one having ordinary skill in the art having had the benefit of the present disclosure that other embodiments that depart from the specific details disclosed herein are certainly possible. Moreover, descriptions of well-known devices, methods, systems and protocols may be omitted so as to not obscure the description of the present invention. Nonetheless, such devices, methods, systems and protocols that are within the purview of one of ordinary skill in the art may be used in accordance with the example embodiments.

Briefly, the example embodiments relate to a wireless communication network and method of wireless communication, which provide for efficient reuse of the spectrum. Characteristically, the example embodiments include virtual channel access, or virtual reservation methods and MAC layers to effect the virtual channel access. One useful method incorporates the transmission and reception of at least one duration value to update the internal network allocation vector (NAV) in a communications session or service interval. As will become clearer as the present description continues, the duration value includes the start and end times of the particular session. According to example embodiments, the information of the Duration Value, which is used to update the NAV, fosters scheduling and collision, while providing improved medium use by certain devices of the network.

Illustratively, one or mode nodes, which receive a request to send for another node (the destination), and which do not receive the clear to send (CTS), are thus outside the range of the destination. These nodes may freely transmit without concern of interfering (e.g., causing collisions of frames) with the destination's reception of the frames (or other type of signal) from the source. As such, spectrum allocation, which, under known methods and networks, would be inefficiently wasted on only the single transmission from the source to the destination, according to example embodiments described herein may be used by one or more nodes that are hidden from the destination.

It is noted that the methods and networks described herein are applicable to certain wireless standards such as IEEE 802.11 and its progeny. In general, the methods and networks are applicable to wireless communication systems that include a virtual channel access (virtual reservation) technique. Of course, there are a variety of virtual reservation protocols within the purview of one of ordinary skill in the wireless communication arts that could be incorporated into the wireless systems of the example embodiments.

FIG. 1 shows a wireless network 100 in accordance with an example embodiment. The wireless network includes a source 101 and a destination 102. The source has a transmission range 103 and the destination 102 has a reception range 104. Also included within the network are nodes 106 and 107. It is noted that there may be more than one destination. To this end, the source 101 may desire to transmit to more than one destination. In this case, the duration value sent will include the scheduling information of the transmission for each destination, each of which will then update its specific NAV. However, in order to avoid collisions/interference with needed CTS's, beneficially there is a mechanism, likely via the NAV, which provides sequential scheduling of the respective CTS's from each destination. The details of such mechanisms of the governing protocols of the MAC layers are within the purview of those ordinarily skilled in the art.

Generally, source 101, destination 102 and nodes 106, 107 may be common devices in a distributed wireless network functioning in accordance with one or more of a number of known protocols and include a distributed MAC layer. Such devices include, but are not limited, to computers, portable computers, personal digital assistants (PDAs), and mobile phones. Illustratively, the network including the source 101, the destination 102 and nodes 106 and 107 function according to the IEEE 802.11 standard or its progeny. Of course, this is merely illustrative and it is noted that other protocols may be used. These include, but are not limited to, Carrier Sensing Multiple Access (CSMA), CSMA with collision avoidance (CSMA/CA), Frequency Division Multiple Access (FDMA) and Time Division Multiple Access (TDMA).

Alternatively, the source 101 and destination 102 may be a host or access point (AP), or wireless devices. Of course, in this example embodiment, the network including the source 101 and nodes 106 includes a centralized or distributed MAC layer and protocol. Finally, it is noted that whether the networks of the example embodiments are centralized or distributed, any network of the example embodiments characteristically include a method of virtual reservation using at least one network allocation vector.

Regardless of the type of network or MAC layer, in certain illustrative embodiments, the source 101 transmits a request to send (RTS) 105, which is received by the destination 102 and by the nodes 106, which are in the source's range 103. In addition, the RTS may be received by at least one node 110, which has a reception range that is within the transmission range of both the source 101 and the destination 102. However, the RTS 105 is not received by the nodes 107. Notably, the source 101 is outside the range of transmission of the nodes 107.

The initial transmission from the source 101 contains the required information in the header to set the NAV for the particular communication session. This header includes the commencement and duration of the session, as well as the intended recipient information; in this case the destination 102. Upon receipt of the header, the destination 102 transmits a CTS 108, which is received by all devices within its transmission range (not shown). As can be appreciated from a review of FIG. 1, this CTS 108 is received by the source 101, the nodes 107 and node(s) 110. Notably, the CTS 108 is not received by the nodes 106, which are outside the transmission range (not shown) of the destination 102.

Under known collision avoidance methods, the receipt of the RTS and CTS by nodes that do not receive both the RTS and CTS, required that these devices remain ‘silent’ during the duration of the session. As such, this protects the receiver (the destination 102) from interference during the transmission session by the source 101. However, the inventors have recognized that such known methods unnecessarily prevent certain devices within the wireless systems from communicating during this session between the source 101 and the destination 102.

As will become clearer as the present description continues in accordance with illustrative embodiments, during the transmission session between the source 101 and the destination 102, nodes that have transmission ranges that are outside the reception range 104 of the destination 102 may communicate with other nodes, which also have a transmission range that is outside the reception range 104 of the destination 102. For example, nodes 106, which have transmission ranges that are not within the reception range 104 may transmit to one another and with node 109, which is outside the transmission range 103.

Moreover, because it is useful to protect receivers of signals (voice, video, or data, or all), but not necessary to protect transmitters of signals, during the transmission session from the source 101 to the destination 102, the nodes 106 and 109 may transmit to the source 101 without deleteriously affecting the function of the source 101. Furthermore, because the nodes 107 are in receipt of the CTS, the commencement of any transmission may begin immediately upon the transmission of the acknowledgement (ACK). These and other example embodiments are described presently.

FIG. 2 is a time line 200 of a wireless network in accordance with an example embodiment. Initially, a source 201 (e.g., source 101) sends an RTS 202, which is received by a destination 203 (e.g., destination 102) and the receivers of the RTS 204 (e.g., nodes 106). After a short inter-frame space (SIFS) 206, the destination 203 sends a CTS 207 to the source 201. From the header in the RTS 202, the duration value for the CTS is set; the source is in a reception-mode, and must be protected from interference from devices (e.g., nodes 106, 109) that have transmission ranges within the reception range of the source 201. As such, after receiving the RTS 202, the receivers of the RTS 204 (e.g., nodes 102, 106, 110) are in a no-transmit or ‘silent’ mode per the NAV 208. It is noted that the NAV 208 may have a duration that only overlaps the CTS 207 as the source may not be in a reception mode until the commencement of the CTS 207.

After transmission of the CTS 207 and another SIFS 209, the source 201 begins the transmission of data 210 in the example embodiment. As can be readily appreciated from the description of the example embodiment of FIG. 1, after termination of the CTS 207, all devices outside the reception range of the destination 203 (e.g., nodes 106, 109) may freely transmit to one another without interfering with the reception of the data 210 by the destination 203. Accordingly, the destination 203 is protected during the transmission of data 210. In the present example embodiment, the receivers of the RTS 204 may begin transmission at the termination of the CTS 207.

However, the windows of time for permissible transmission by the receivers of the CTS 205 (e.g., nodes 107) are quite different than those of the receivers of the RTS. During the RTS 202 and before the completion of the CTS, the receivers of the CTS 205 are unaware of the pending transmission of the data, as they have not received the header information for a NAV. As such, during the period 211, which terminates with the CTS 207, the receivers of the CTS 204 may transmit and receive information without interfering with a receiver in their range of transmission. Thus, the receivers of the network are protected.

After the termination of the CTS 207, the receivers of the CTS 205 remain in a no-transmit or ‘silent’ mode for the duration of the data transmission, which is NAV 212. From the CTS 207, the receivers of the CTS 205 have the termination point of the transmission of data 210 and have set a NAV 212 to this termination point. Thus, at the end of the transmission of the data 210, the receivers of the CTS 207 may commence transmission once again. This transmission period begins at 213. The commencement and duration of the quiet time of the receivers of the CTS 205 is effect via the CTS 202, which sets the NAV 212 for the receivers 205.

As can be appreciated, the quiet ‘silent’ observed by the receivers of the CTS 205 during the transmission of the data provides the protection of the receivers of the network. For example, in the example embodiment of FIG. 1, the nodes 107, which receive the CTS are not transmitting during the time that the destination 102 is receiving from the source. However, before the destination enters receive-mode, the nodes 107 may transmit, especially when the destination is transmitting the CTS. To this end, the nodes, having a transmission range that is outside the reception range of the source 101, will not interfere with this receiver by transmitting during the transmission of the CTS. The scheduling of the transmission by the receivers of the CTS 205 during the transmission at the end of the transmission of the data 210 is effected via the CTS 202, which sets the NAV 212 for the receivers 205.

Upon completion of the transmission of data 210, and at the end of a second SIFS 214, the receivers of the RTS 204 (e.g., nodes 102, 106, 110) must terminate transmission. This protects the source 201 from interference during the transmission of an ACK 215 by the destination 203. To wit, the reception range of the destination is within the transmission range of the receivers of the RTS 204, and thus protection of the receiver (the destination 203) requires all devices that can transmit within the reception range of the destination 203 must remain ‘silent’ until the ACK 215 is completed. The scheduling of this quiet period is from the RTS 202, which sets a NAV 216 for the receivers 204.

It is noted that there may be devices 110 within range of both source 201 and destination 203. These devices 110 will receive both RTS 202 and CTS 207, and therefore will set the NAV during time slots 208, 212 and 216 periods of time. These devices 110 cannot re-use the spectrum and will keep silent during the communication between 201 and 203.

Finally, it is noted that according to illustrative embodiments, the RTS/CTS exchange may not be needed, since the duration value used to update NAVs is included in Data Frames sent during the transmission. For example the source 201 can transmit a data frame directly without the need of the RTS 202. However, the destination will not reserve the medium around it, and protect itself from hidden nodes since it did not have an opportunity to send the CTS 207.

FIG. 3 shows a time line 300 of a wireless communication network of another example embodiment. The wireless network may be of the type described in connection with the example embodiment of FIG. 1, and includes one or more virtual channel access method. Illustratively, the methods of the example embodiments of FIG. 3 provide efficient use of the medium when known burst ACK or No ACK methods of the proposed 802.11e protocol are used in connection with TXOP bursting. Of course, in order to avoid obscuring the description of the present example embodiments, many common details of the embodiments of FIGS. 1 and 2 are not repeated.

A source 301 transmits an RTS 305 to at least one destination 302. After an SIFS 306, the destination 302 transmits a CTS 307 back to the source 301. As before, the reception of the RTS 305 by the receivers of the RTS 303 and of the CTS 307 by the receivers of the CTS 304, set NAVs 308 and 309, and NAV 310, respectively. After a second SIFS 311 a sequence of data transmissions 312-314 separated by SIFS intervals 315 are made by the source 301. It is noted that there may be more or fewer data transmissions than those shown.

After the final transmission, a request for a Block ACK 316 is sent by the source 301; and after another SIFS. 317, a Block ACK is sent by the destination 302.

Receivers of the RTS 303 (e.g., nodes 106, 110) can use the medium during the transmission of data 312-314, the SIFSs 315 and the Block ACK Request 316. Beneficially, this provides a significant time for these devices to communicate among themselves and with other devices outside the range of reception of the destination 302. In fact, only during periods where the source needs to be in reception mode (NAV 308 and 309, which overlap the CTS 307 and Block ACK Response 318, respectively) the receivers of the RTS may transmit. This provides a significant improvement in efficiency compared to other known methods and protocols.

Prior to completion of the CTS 307, the receivers of the CTS may transmit without interfering with the reception of the destination. Also, after the NAV 310, these devices may transmit as well; again because the destination 302 is not receiving. This also provides a significant improvement in efficiency compared to other known methods and protocols.

As described in the example embodiment of FIG. 2, there may be devices 110 within range of both source 301 and destination 303. These devices 110 will receive both RTS 305 and CTS 307, and therefore will set the NAV during 308, 309 and 310 periods of time. These devices 110 cannot re-use the spectrum and will keep silent during the communication between source 301 and 302.

Finally, it is noted that according to the example embodiments of FIGS. 2 and 3, the header of the RTS 202 and 305 may include an offset in addition to the duration and identification of the destination(s). This offset field in the header specifies the time between the end of the reception of the RTS frame and the time that the NAV 216 in FIG. 2 and NAV 309 in FIG. 3 will be set. It is further noted, that devices 106 and 107 do not necessarily require this offset information in the RTS and could set the NAV 216 or NAV 309 carrying complex calculations and subtracting the ACK or Block ACK response frame times from the duration of the planned frame sequence.

In view of this disclosure it is noted that the various methods and devices described herein can be implemented in hardware and software known to achieve sharing of a medium between devices in at least one wireless network using virtual reservation methods. Further, the various methods and parameters are included by way of example only and not in any limiting sense. In view of this disclosure, those skilled in the art can implement the various example devices and methods in determining their own techniques and needed equipment to effect these techniques, while remaining within the scope of the appended claims.

1. A wireless network, comprising:
a source (101) that transmits a signal to at least one destination during a scheduled time period; and
at least one node (106, 109), which is hidden from the destination, and which transmits a signal during the scheduled time period.

2. A wireless network as recited in claim 1, wherein the source transmits a request to send (RTS) (202) to the at least one destination and the RTS includes a transmission duration and recipient information.

3. A wireless network as recited in claim 2, wherein at least one node (106) does not receive the RTS.

4. A wireless network as recited in claim 3, wherein the destination sends a clear to send (CTS) (207) transmission to the source after receiving the RTS, and at least one node that receives the RTS does not receive the CTS.

5. A wireless network as recited in claim 4, wherein the network includes at least one node (107) that receives the CTS.

6. A wireless network as recited in claim 2, wherein at least one node in the network receives the RTS and sets at least one network allocation vector (208, 216) during which the at least one node does not transmit.

7. A wireless network as recited in claim 6, wherein the at least one node that receives the RTS transmits during at least a portion of the scheduled time period.

8. A wireless network as recited in claim 5, wherein the at least one node that receives the CTS does not transmit during the scheduled time period.

9. A wireless network as recited in claim 8, wherein the at least one node that receives the CTS transmits during a transmission of an acknowledgement (ACK) by the at least one destination.

10. A wireless network as recited in claim 1, wherein the transmission during the scheduled time period includes at least one data frame.

11. A wireless network as recited in claim 1, wherein the source transmits a frame to at least one destination and the frame includes transmission duration and recipient information.

12. A wireless network as recited in claim 11, wherein the destination sends a response transmission to the source after receiving the frame and at least one node that receives the frame does not receive the response.

13. A method of wireless communication in a wireless network, the method comprising:
providing a source (101) that transmits a signal to at least one destination (102) during a scheduled time period; and
providing at least one node (106), which is hidden from the destination, and which transmits a signal during the scheduled time period.

14. A method as recited in claim 13, wherein the source transmits a request to send (RTS) (202) to the at least one destination and the RTS includes a duration value and recipient information.

15. A method as recited in claim 14, wherein at least one node in the network does not receive the RTS.

16. A method as recited in claim 14, wherein the destination sends a clear to send (CTS) (207) transmission to the source after receiving the RTS, and the least one node (106) does not receive the CTS.

17. A method as recited in claim 16, wherein the network includes at least one node (107) that receives the CTS.

18. A method as recited in claim 15, wherein at least one node in the network receives the RTS and sets at least one network allocation vector (NAV) (208) during which the at least one node does not transmit.

19. A method as recited in claim 18, wherein the at least one node that receives the RTS transmits during at least a portion of the scheduled time period.

20. A method as recited in claim 17, wherein the at least one node that receives the CTS does not transmit during the scheduled time period.

21. A method as recited in claim 20, wherein the at least one node that receives the CTS transmits during a transmission of an acknowledgement (ACK) (215) by the at least one destination.

22. A method as recited in claim 13, wherein the transmission during the scheduled time period includes at least one data frame.

23. A method as recited in claim 13, wherein the source transmits a frame to at least one destination and the frame includes a duration value and recipient information.

24. A method as recited in claim 23, wherein the destination sends a response transmission to the source after receiving the frame and at least one node that receives the frame does not receive the response.

25. A wireless network as recited in claim 2, wherein a header of the RTS 202 may include an offset in addition to a duration value and an identification of the destination, and the offset specifies a time between the end of the reception of the RTS and the time that a network allocation vector (NAV) is set.

26. A wireless network as recited in claim 4, further comprising at least one node (110), which receives both the RTS and the CTS.

27. A method as recited in claim 17, wherein the network includes at least one node (110), which receives both the RTS and the CTS.
